(19) United States
(12) Patent Application Publication
(10) Pub. No.: US 2015/0205593 A1
(43) Pub. Date: Jul. 23, 2015

(54) INFORMATION PROCESSING DEVICE, SYSTEM, INFORMATION PROCESSING METHOD AND COMPUTER READABLE NON-TRANSITORY MEDIUM

(71) Applicant: FUJITSU LIMITED, Kawasaki-shi (JP)

(72) Inventors: Koichi YOKOTA, Yokohama (JP); Hideki TANAKA, Kawasaki (JP); Zhaogong GUO, Koto (JP)

(73) Assignee: FUJITSU LIMITED, Kawasaki (JP)

(21) Appl. No.: 14/672,401

(22) Filed: Mar. 30, 2015

Related U.S. Application Data
(63) Continuation of application No. PCT/JP2012/076010, filed on Oct. 5, 2012.

(51) Int. Cl. G06F 9/445

(52) U.S. Cl. CPC G06F 8/61

(57) ABSTRACT

An information processing device includes: a memory; and a circuitry, wherein the circuitry is configured: to read identification information for identifying an application software installed in a terminal and information relating to a usage condition of the application software in the terminal from the terminal; and to select a candidate application software and a candidate terminal to which the application software is served, based on the read identification information and the read information relating to the usage condition.

### CROSS-REFERENCE TO RELATED APPLICATION

This application is a continuation application of PCT/JP2012/076010 filed on Oct. 5, 2012 and designated the U.S., the entire contents of which are incorporated herein by reference.

### FIELD

A certain aspect of embodiments described herein relates to an information processing device, a system, a information processing method and a computer readable non-transitory medium.

### BACKGROUND

Recently, an application software (hereinafter referred to as an app) is often downloaded from an application store (hereinafter referred to as an app store), and the application is used. A terminal using the app is a smartphone, a tablet terminal, a notebook computer and so on. Reviews of app users are written in introduction pages of each app provided by an app store. And so, users determine which app to download by reference to the reviews.

Japanese Patent Application Publications No. 2000-222296 and No. 2012-14442 disclose a technology in which files or applications served to or recommended to terminals are selected. Japanese Patent Application Publication No. 2003-50719 discloses a technology in which a usage condition is monitored.

However, anyone can write reviews with respect to apps. Therefore, the reviews is not always a reference to select an app having high practicality.

### SUMMARY

According to an aspect of the present invention, there is provided an information processing device including: a memory; and a circuitry, wherein the circuitry is configured: to read identification information for identifying an application software installed in a terminal and information relating to a usage condition of the application software in the terminal from the terminal; and to select a candidate application software and a candidate terminal to which the application software is served, based on the read identification information and the read information relating to the usage condition.

According to another aspect of the present invention, there is provided a system including: an information processing device that has a memory and a circuitry, the circuitry being configured to read identification information for identifying an application software installed in a terminal and information relating to a usage condition of the application software in the terminal from the terminal and to select a candidate application software and a candidate terminal to which the application software is served, based on the read identification information and the read information relating to the usage condition; and the terminal that has a memory and a circuitry, the circuitry being configured to send the identification information and the information relating to the usage condition of the application software to the information processing device.

According to another aspect of the present invention, there is provided an information processing method including: reading identification information for identifying an application software installed in a terminal and information relating to a usage condition of the application software in the terminal from the terminal; and selecting a candidate application software and a candidate terminal to which the application software is served, based on the identification information and the information relating to the usage condition that are read in the reading.

According to another aspect of the present invention, there is provided a computer readable, non-transitory medium storing a program that causes a computer to execute a process, the process comprising: reading identification information for identifying an application software installed in a terminal and information relating to a usage condition of the application software in the terminal from the terminal; and selecting a candidate application software and a candidate terminal to which the application software is served, based on the identification information and the information relating to the usage condition that are read in the reading.

### BRIEF DESCRIPTION OF DRAWINGS

FIG. 1 illustrates an example of a system structure of a first embodiment;

FIG. 2 illustrates an example of hardware of an administration device to serve applications;

FIG. 3 illustrates an example of hardware of a terminal;

FIG. 4 illustrates an example of hardware of a server device;

FIG. 5 illustrates an example of a functional block of a control unit of an administration device to serve applications;

FIG. 6A illustrates an example of a user administration table;

FIG. 6B illustrates an example of an app administration table for each terminal;

FIG. 7 illustrates an example of a functional block of a control unit of a terminal;

FIG. 8 illustrates an example of a system structure in a case where a common use server in a company is used as an administration device to serve applications;

FIG. 9 illustrates a flowchart of a procedure in which a control unit of a terminal collects information relating to a usage condition of an app;

FIG. 10 illustrates a flowchart of a procedure in which a control unit of a terminal sends information relating to a usage of an app to an administration device to serve applications;

FIG. 11 illustrates a flowchart of a procedure of an administration device to serve applications that is requested to send data by a terminal;

FIG. 12 illustrates a flowchart of a procedure in which a control unit of an administration device to serve applications of a first embodiment selects an app to be served and a terminal to which the app is served;

FIG. 13 illustrates an example of a functional block of a control unit of an administration device to serve applications of a second embodiment;

FIG. 14A illustrates an example of a group administration table;

FIG. 14B illustrates an example of an app administration table for each terminal;

FIG. 15 illustrates a communication sequence among a terminal, an administration device to serve applications and a server device;

FIG. 16 illustrates a flowchart of a procedure in which a control unit of an administration device to serve applications of a second embodiment selects an app to be served and a terminal to which the app is served;

FIG. 17 illustrates a flowchart of a procedure in which an administration device to serve applications requests a server device to serve an app to a terminal; and

FIG. 18 illustrates another flowchart of a procedure in which a control unit of an administration device to serve applications of a second embodiment selects an app to be served and a terminal to which the app is served.

### DESCRIPTION OF EMBODIMENTS

### First Embodiment

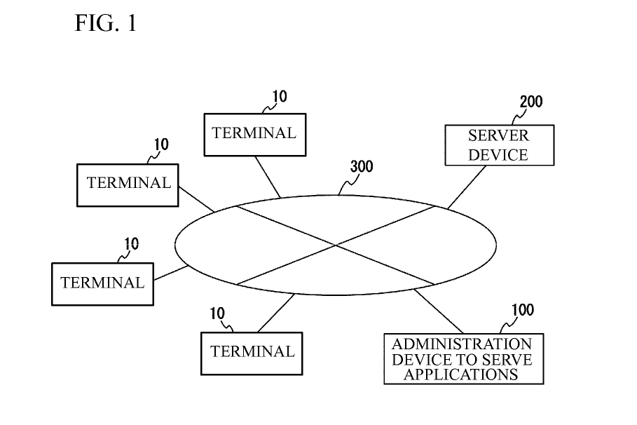

A description will be given of a first embodiment with reference to FIG. 1 to FIG. 12. FIG. 1 illustrates an example of a system structure of the first embodiment. As illustrated in FIG. 1, the first embodiment has a plurality of terminals 10, an administration device 100 to serve applications, and a server device 200. The plurality of terminals 10, the administration device 100 to serve applications and the server device 200 are connected via a network 300 such as a LAN (Local Area Network), a WAN (Wide Area Network), or Internet. FIG. 1 illustrates an example in which the terminals 10 are connected with the network 300 via a fixed line. In addition to this structure, a mobile communication used for a wireless communication such as a wireless LAN or mobile phones can be used as a connection path between the terminals 10 and the network 300.

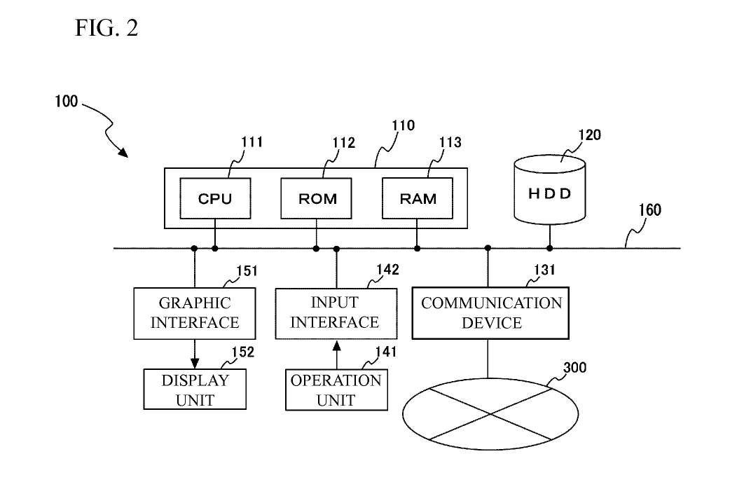

First, a description will be given of the administration device 100 to serve applications that is an example of an information processing device. FIG. 2 illustrates an example of hardware of the administration device 100 to serve applications. The administration device 100 to serve applications has a control unit 110. The control unit 110 has a CPU (Central Processing Unit) 111, a ROM (Read Only Memory) 112 and a RAM (Random Access Memory) 113. The CPU 111, the ROM 112 and the RAM 113 are connected to a bus 160 respectively.

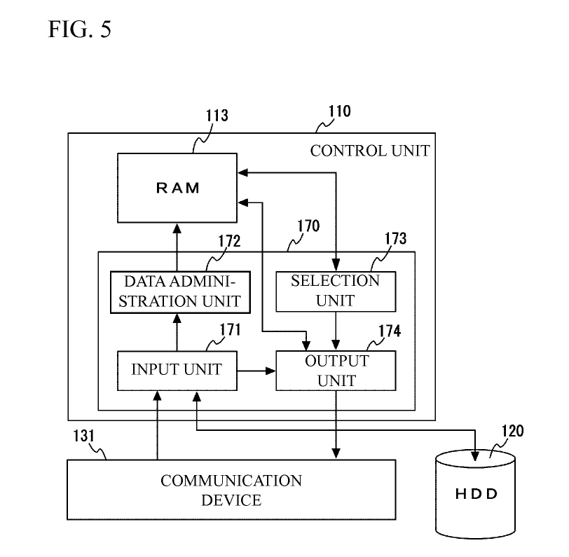

The ROM 112 stores a control program which the CPU 111 uses for controlling. When the power of the administration device 100 to serve applications is on and the administration device 100 to serve applications starts, the CPU 111 reads the control program from the ROM 112 and stores the control program in the RAM 113. After that, the CPU 111 performs processes (calculations) in accordance with the control program stored in the RAM 113. The RAM 113 is used for a work memory of the CPU 111 and stores data which the CPU 111 uses for calculations, data after calculations by the CPU 111 and so on. Functional blocks achieved by co-working of the hardware such as the CPU 111 and the RAM 113, and the control program stored in the ROM 112 will be described later with reference to FIG. 5.

The administration device 100 to serve applications has a hard disk device (hereinafter referred to as HDD) 120 as a storage device. The HDD 120 is connected to the bus 160. The HDD 120 stores necessary data when the power of the administration device 100 to serve applications is off. As examples of the data, there are data stored in a user administration table, an app administration table for each terminal, and a group administration table that are described later. The HDD 120 also can store the apps served to the terminals 10. For example, the administration device 100 to serve applications may access the server device 200 in advance, may read apps from the server device 200, and may store the apps in the HDD 120.

The administration device 100 to serve applications has a communication device 131. The communication device 131 is connected to the bus 160. And, the communication device 131 is connected to the network 300 in accordance with the control of the control unit 110, and performs a data communication with the terminals 10 or the server device 200 that are connected to the network 300.

The administration device 100 to serve applications has an operation unit 141 and an input interface 142. The input interface 142 is connected to the bus 160, and is connected to the operation unit 141. The operation unit 141 is a receiving unit to receive an operation of a user. Information of the operation received by the operation unit 141 is sent to the control unit 110 via the input interface 142.

The administration device 100 to serve applications has a graphic interface 151 and a display unit 152. The graphic interface 151 is connected to the bus 160 and is connected to the display unit 152. The graphic interface 151 is an interface to make the display unit 152 display a graphic data processed by the control unit 110 and converts the graphic data into a wave electrical signal in order to make the display unit 152 display the graphic data. The display unit 152 receives the wave electrical signal that is output by the graphic interface 151 and displays the received wave electrical signal on a display screen.

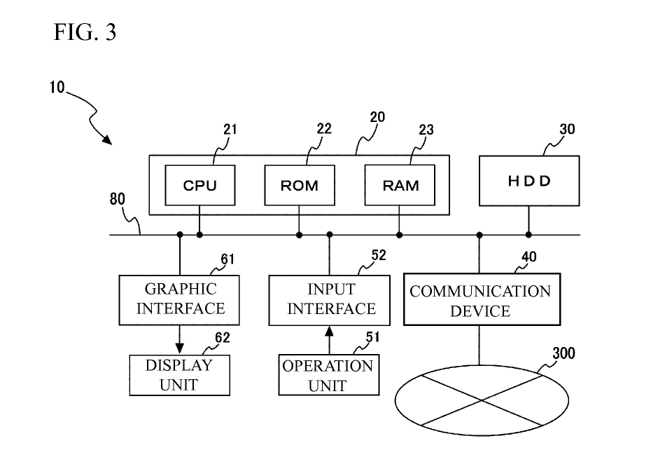

FIG. 3 illustrates an example of hardware of the terminal 10. FIG. 3 illustrates the hardware of the terminal 10 in a case where the terminal 10 is a notebook PC. However, the terminal 10 may be a smart phone or a tablet terminal. The terminal 10 has a control unit 20, a HDD 30, a communication device 40, an operation unit 51, an input interface 52, a graphic interface 61 and a display unit 62. Processes of the hardware of the terminal 10 are substantially the same as the processes of the corresponding hardware of the administration device 100 to serve applications. Therefore, an explanation of the processes is omitted. When the terminal 10 is a smart phone or a tablet terminal, the terminal 10 may have a SSD (Solid State Drive) acting as a storage device using a non-volatile memory instead of the HDD 30 although the SDD is not illustrated in FIG. 3. When the terminal 10 is a smart phone or a tablet terminal, the terminal 10 may have a touch sensor that detects the operation of the display screen of the display unit 62. And, when the terminal 10 is a smart phone, the terminal 10 may have a speaker and a microphone.

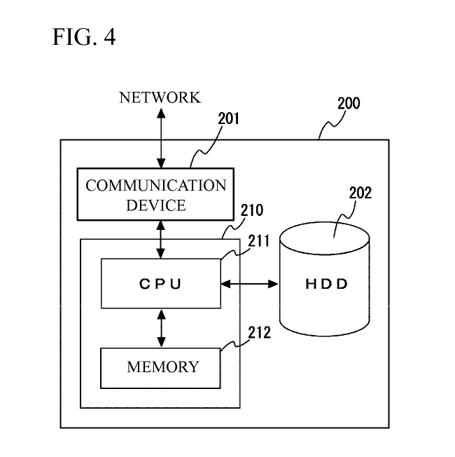

FIG. 4 illustrates an example of hardware of the server device 200. The server device 200 has a communication device 201, a HDD 202 and a control unit 210 as the hardware. The control unit 210 has at least a CPU 211 and a memory 212. The memory 212 has a ROM and a RAM. When the control unit 210 receives a request of connection via the network 300, the control unit 210 requests a registration of a user to a source device that sends the request of connection. The control unit 210 stores registration information of a user registration that is sent from the source device in the memory 212. When the source device is a device of a user who is registered in advance, a transmission of a user ID and a password that are registered in the user registration is sent to the source device and a user authentication is performed. When the user authentication is succeeded, the server device 200 reads an app that is requested from the source device from the HDD 202, and serves the application to the source device.

FIG. 5 illustrates an example of a functional block 170 of the control unit 110 of the administration device 100 to serve applications. The functional block 170 is a block in which each process achieved by co-working of hardware of the control unit 110 such as the CPU 111 and the RAM 113, and the control program stored in the ROM 112 is classified into functions achieved by series processes. The control unit 110 has an input unit 171, a data administration unit 172, a selection unit 173 and an output unit 174 as the functional block 170.

The input unit 171 receives information which the communication device 131 receives from the terminal 10. The input unit 171 outputs input information or the like to the data administration unit 172. The input unit 171 outputs data such as apps that is read from the HDD 120 to the output unit 174.

The data administration unit 172 receives the information that is output by the input unit 171. The information includes terminal-identification information for identifying a terminal 10, app-identification information for identifying an app, and information relating to a usage condition of the app. Details of the information will be described later. The data administration unit 172 stores the received information in the RAM 113. The RAM 113 stores the user administration table and the app administration table for each terminal The data administration unit 172 stores the information received from the terminal 10 in the app administration table for each terminal.

The selection unit 173 refers to the user administration table and the app administration table for each terminal, selects an app served to the terminal 10, and selects the terminals 10 to which the selected application is served. The selection unit 173 outputs information relating the selected app and information relating to the selected terminal 10.

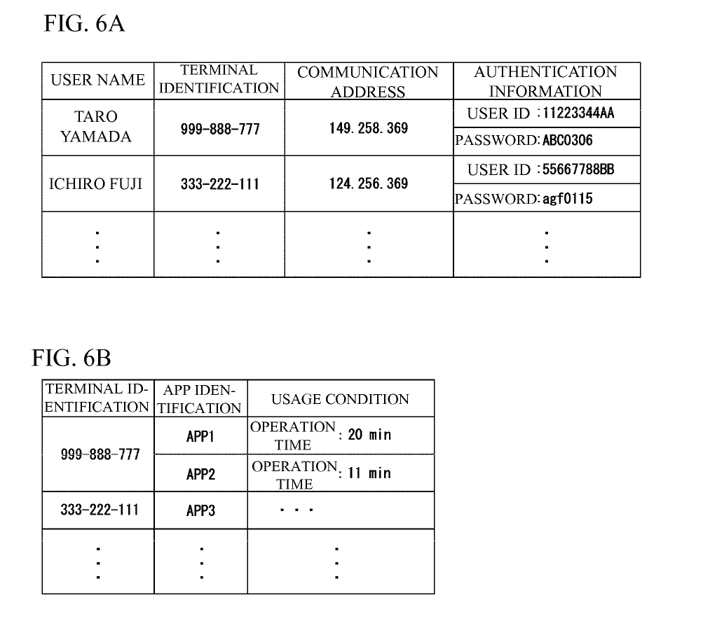

With reference to FIG. 6A, a description will be given of an example of the user administration table. The user administration table relates terminal-identification information, a communication address and authentication information to a user name and stores the terminal-identification information, the communication address and the authentication information. The user name is a name of a user that uses the terminal 10. The terminal-identification information is information for identifying the terminal 10 that the user having the user name uses. The terminal-identification information may be set by the user of the terminal 10. And, the terminal 10 may send the terminal-identification information to the administration device 100 to serve applications. Alternatively, the administration device 100 to serve applications may set the terminal-identification information with respect to each of the terminals 10 and may send the terminal-identification information to each of the terminals 10. The communication address is an address for communicating with the terminal 10 indicated by the terminal-identification information. For example, the communication address includes at least one of a MAC (Media Access Control) address and an IP (Internet Protocol) address. The authentication information is information for the server device 200 to authenticate the user and includes a user ID (identification) and a password.

FIG. 6B illustrates an example of the app administration table for each terminal. Information enrolled in the app administration table for each terminal includes the terminal-identification information, the app-identification information and the information relating to the usage condition. The terminal-identification information is the same as the terminal-identification information enrolled in the user administration table. The app-identification information is information for identifying an app installed in the terminal 10 indicated by the terminal-identification information. For example, when the app is an application of Android (registered trademark) of Google (registered trademark), the app-identification information is a package name in which domain is arrayed in a reverse direction from a top level domain. The information relating to the usage condition is an accumulated time of times in which the app indicated by the app-identification information is used by the terminal 10 indicated by the terminal-identification information for a predetermined time. For example, the information relating to the usage condition is an accumulated time of operation times of the app of one month.

With reference to FIG. 5 again, a description will be given of the functional block 170 of the control unit 110 of the administration device 100 to serve applications. The selection unit 173 refers to the app administration table for each terminal and selects an app served to the terminal 10. For example, the app administration table of FIG. 6B stores the app-identification information for identifying applications installed in each terminal 10 and the operation time of apps as the information relating to the usage condition of the apps. The selection unit 173 refers to the app administration table for each terminal and detects an application satisfying a condition that the number of the installed terminals is a predetermined value or more and the operation time of the app is a predetermined time or more. The selection unit 173 selects the app satisfying the condition as an app served to the terminal 10. The selection unit 173 refers to the app administration table for each terminal and detects a terminal 10 in which the selected app is not installed. In the following, the app selected by the selection unit 173 is referred to as a candidate app. And, the terminal 10 in which the candidate app detected by the selection unit 173 is not installed is referred to as a candidate terminal 10. The selection unit 173 outputs the app-identification information of the candidate app and the terminal-identification information of the candidate terminal 10 to the output unit 174.

The output unit 174 receives the app-identification information of the candidate app and the terminal-identification information of the candidate terminal 10 that are output by the selection unit 173. The output unit 174 receives the app-identification information of the candidate app and the terminal-identification information of the candidate terminal 10 and outputs information for serving the candidate app to the candidate terminal 10. In concrete, the output unit 174 refers to the user administration table and reads authentication information that is related to the terminal-identification information and is registered and the communication address. The output unit 174 accesses the server device 200 and performs an authentication with the server device 200 with use of the read authentication information. When the authentication is normally terminated, the output unit 174 outputs the information indicating the communication address of the candidate terminal 10 that is read from the user administration table and the information requesting serving of the candidate app to the candidate terminal 10 to the communication device 131. That is, the authentication information, the communication address of the candidate terminal 10 and the information requesting of the serving of the candidate app to the candidate terminal 10 correspond to the information for serving of the candidate app to the candidate terminal 10. The communication device 131 sends the received information to the server device 200. When the server device 200 stores the communication address of the terminal 10 in advance, it is not necessary for the administration device 100 to serve applications to send the communication address to the server device 200. When the HDD 120 of the administration device 100 to serve applications stores the candidate app that is read from the server device 200 in advance, the output unit 174 reads the candidate app from the HDD 120 and serves the candidate app to the candidate terminal 10. In this case, the output unit 174 outputs the candidate app that is read from the HDD 120 and the candidate terminal 10 to which the candidate app is served to the communication device 131. Therefore, the candidate app that is read from the HDD 120 and the communication address of the candidate terminal 10 correspond to the information for serving the candidate app to the candidate terminal 10.

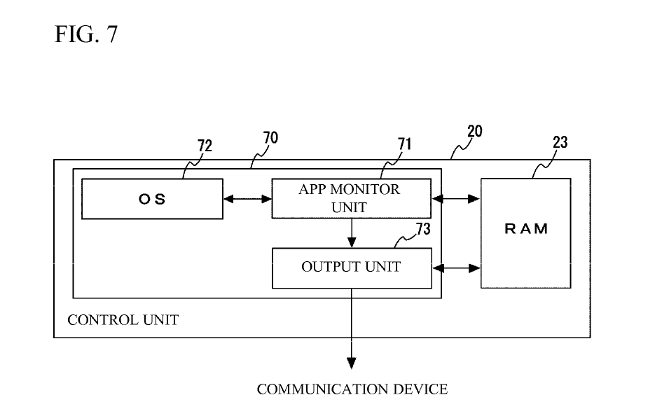

FIG. 7 illustrates an example of a functional block 70 of the control unit 20 of the terminal 10. The terminal 10 has an app monitor unit 71, an OS (Operating System) 72 and an output unit 73 as the functional block 70. Every predetermined time, the app monitor unit 71 asks the OS 72 whether there is an app that is started or terminated, and reads app-identification information of the app that is started or terminated. When the app monitor unit 71 reads the app-identification information of the app that is started from the OS 72, the app monitor unit 71 determines the time at which the app-identification information is read to be a start time at which the usage of the app starts. When the app monitor unit 71 reads the app-identification information of the app that is terminated from the OS 72, the app monitor unit 71 determines the time at which the app-identification information is read to be an end time at which the usage of the application is terminated. The app monitor unit 71 calculates an operation time of the app from the start time and the end time that are determined by the app monitor unit 71, relates the calculated operation time to the app-identification information and stores the operation time in a RAM 23. For example, when the OS 72 is Windows (registered trademark), a task manager administrates the information relating to the app that is started or terminated. It is possible to collect the information from the task manager. When the OS 72 is Android (registered trademark), an activity manager administrates the information relating to the app that is started or terminated. It is possible to collect the information from the activity manager.

The output unit 73 reads information from the RAM 23 and sends the information to the administration device 100 to serve applications. The output unit 73 determines whether there is a changing in the information relating to the usage condition stored in the RAM 23 at a predetermined date such as once every day, once every week or the like. When it is determined that there is a changing in the information relating to the usage condition, the output unit 73 adds app-identification information of an app corresponding to the information relating to the usage condition and terminal-identification information to the information relating to the changed usage condition. The output unit 73 sends the changed information relating to the usage condition, the app-identification information and the terminal-identification information to the administration device 100 to serve applications.

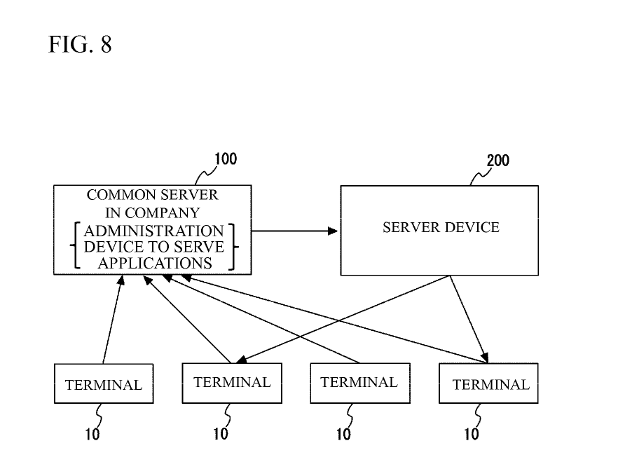

The administration device 100 to serve applications may be provided as a part of functions of a common use server in a company or a server of SNS (Social Networking Service). Anyone can write a user review of an introduction page of an app provided by the server device 200 without inhibition. Therefore, the user review is not always an index for determining an app having a high practicality. Applications that are stored in the server device 200 and can be downloaded include useful applications and ill-intentioned applications. Therefore, when the terminal 10 is supplied to a company member from the company, it is sometimes troublesome that a user of the terminal 10 installs a preferable app without permission. And so, as illustrated in FIG. 8, the common use server in a company has a function of the administration device 100 to serve applications. And, the common use server in the company selects a candidate app and candidate terminal 10 to which the app is served. And, the candidate app and the candidate terminal 10 that are selected by the common use server in the company are reported to the server device 200. Thereby, it is possible to serve an app having high practicality to the candidate terminal 10.

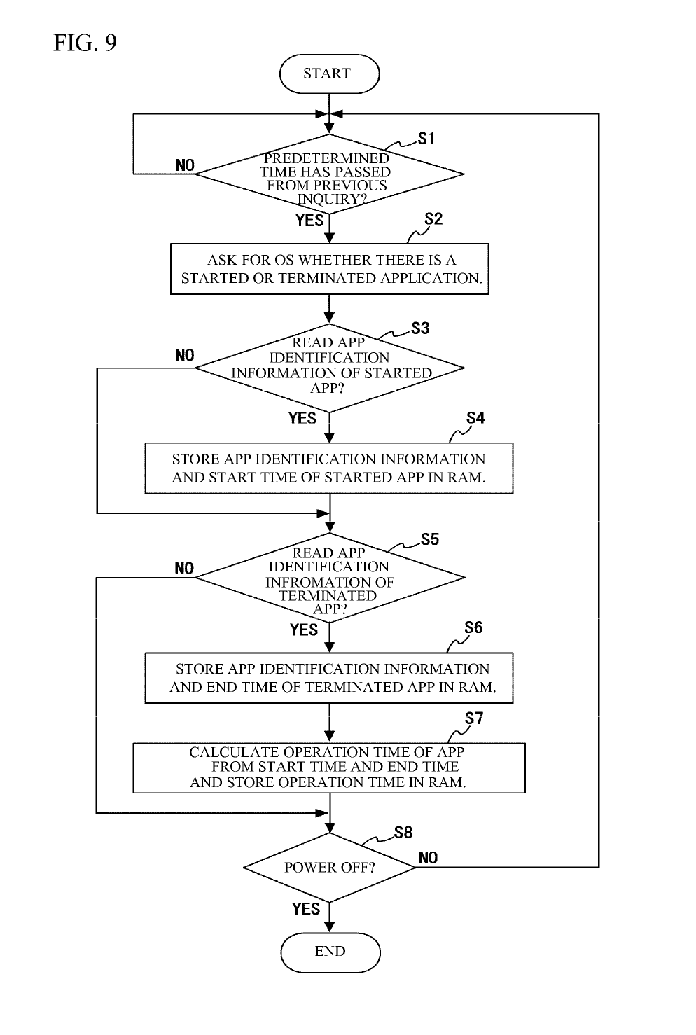

Next, a description will be given of a procedure of the control unit 20 of the terminal 10. First, a description will be given of a collecting process of information relating to a usage condition of an app by the control unit 20, with reference to a flowchart of FIG. 9. The control unit 20 determines whether a predetermined time has passed from a previous inquiry to the OS 72 (Step S1). When it is determined as “No” (Step S1/No), the control unit 20 waits until the predetermined time passes. When it is determined as “Yes” (Step S1/Yes), the control unit 20 asks for the OS 72 whether there is an app that is started or terminated (Step S2). When the control unit 20 reads app-identification information of the app that is started from the OS 72 (Step S3/Yes), the control unit 20 determines the time at which the app-identification information is read to be a start time of the application. And, the control unit 20 relates the app-identification information to the start time, and stores the app-identification information in the RAM 23 (Step S4). When the control unit 20 reads the app-identification information of the terminated application from the OS 72 (Step S5/Yes), the control unit 20 determines the time at which the app-identification is read to be the end time of the app. And, the control unit 20 relates the read app-identification information to the end time and stores the app-identification information in the RAM 23 (Step S6). Further, the control unit 20 uses the start time and the end time of the application having the same app-identification information and calculates an operation time of the app. The control unit 20 relates the calculated operation time to the app-identification information and stores the operation time in the RAM 23 (Step S7). When the storing into the RAM 23 is terminated or it is determined as “No” in Step S5 (Step S5/No), the control unit 20 determines whether the power supply of the terminal 10 is off (Step S8). When it is determined as “No” (Step S8/No), the control unit 20 repeats the processes from the Step 51. When it is determined as “Yes” (Step S8/Yes), the control unit 20 terminates the procedure.

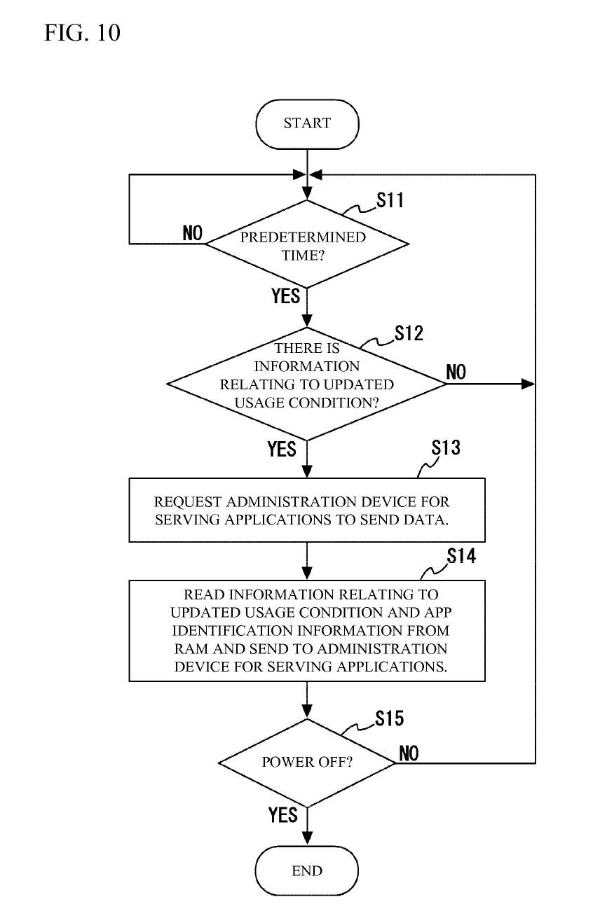

A description will be given of procedures of sending information relating to the usage condition of the collected app from the terminal 10 to the administration device 100 to serve applications, with reference to a flowchart of FIG. 10. The control unit 20 sends the information relating to the usage condition of the collected app to the administration device 100 to serve applications at a predetermined time once every day, for example. The control unit 20 determines whether a current time is the predetermined time (Step S11). When it is determined as “No” (Step S11/No), the control unit 20 waits until the predetermined time. When it is determined as “Yes” (Step S11/Yes), the control unit 20 determines whether there is updated information relating to the usage condition stored in the RAM 23 (Step S12). When it is determined as “No” (Step S12/No), the control unit 20 executes a determination of Step S15. When it is determined as “Yes” (Step S12/Yes), the control unit 20 requests the administration device 100 to serve applications to send data (Step S13). When the control unit 20 receives a response to allow the sending of the date from the administration device 100 to serve applications, the control unit 20 reads app-identification information and updated information relating to the usage condition from the RAM 23. The control unit 20 adds terminal-identification information for identifying the terminal 10 to the app-identification information and the updated information relating to the usage condition, and sends the app-identification information and the information relating to the usage condition to the administration device 100 to serve applications (Step S14). When the data sending is terminated, the control unit 20 determines whether the power supply of the terminal 10 is off (Step S15). When it is determined as “Yes” (Step S15/Yes), the control unit 20 terminates the process. When it is determined as “No” (Step S15/No), the control unit 20 repeats the processes from Step S11.

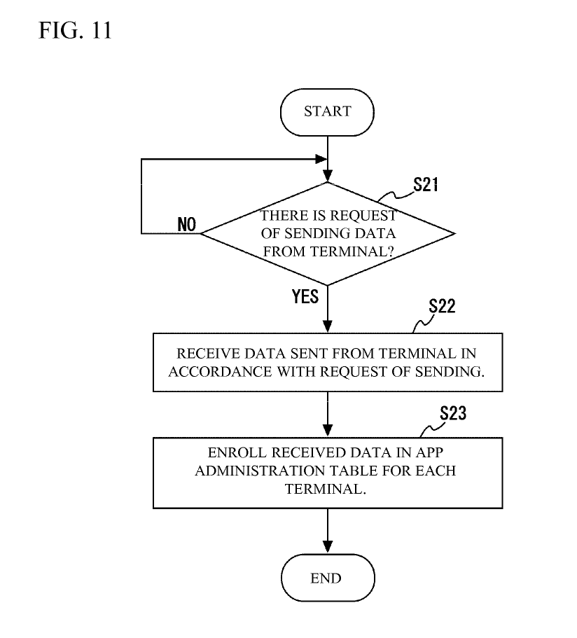

Next, a description will be given of procedures of the control unit 110 of the administration device 100 to serve applications. First, a description will be given of procedures of the control unit 110 in a case where the request of the data sending is received from the terminal 10, with reference to a flowchart of FIG. 11. When the control unit 110 receives the request of the data sending from the terminal 10 (Step S21/Yes), the control unit 110 replies an allowance or non-allowance of the data sending to the terminal 10. When the control unit 110 allows the data sending, the control unit 110 receives data that is sent by the terminal 10 (Step S22). The control unit 110 enrolls the received data in the app administration table for each terminal (Step S23). The data sent by the terminal 10 includes app-identification information, information relating to a usage condition of an app and terminal-identification information. The control unit 110 reads the terminal-identification information and the app-identification information from the received data and enrolls the information relating to the usage condition in a column of the app administration table corresponding to the terminal-identification information and the app-identification information. When the information relating to the usage condition sent by the terminal 10 is information indicating an operation time of an app, the control unit 110 adds the operation time that is currently received from the terminal 10 to the operation time that is enrolled in the column of the application administration table for each terminal. The control unit 110 enrolls the operation time after adding in the application administration table for each terminal and updates the data.

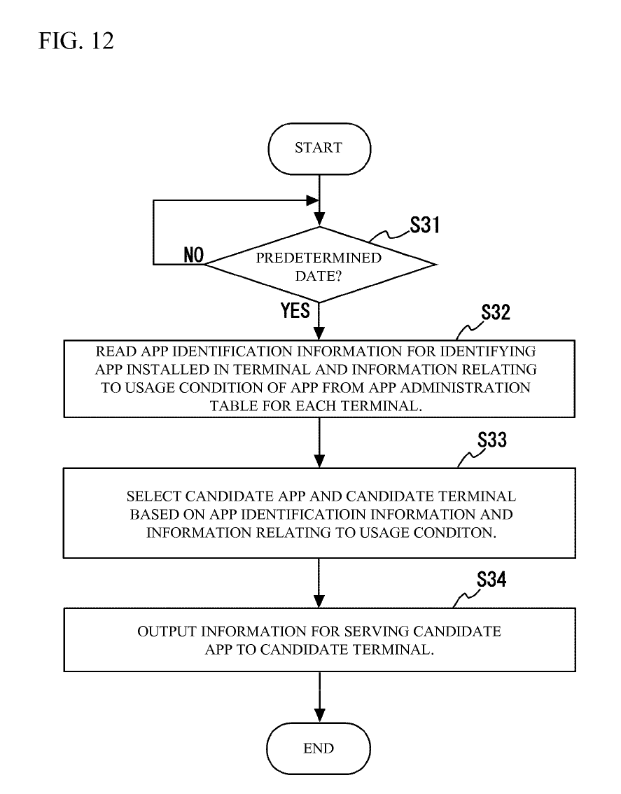

Next, a description will be given of procedures of the control unit 110 for selecting a candidate app and a candidate terminal 10, with reference to a flowchart of FIG. 12. The following description is under a condition that the control unit 110 performs a process of selecting the candidate app and the candidate terminal 10 at a predetermined date such as once a week. The control unit 110 determines whether a current date is the predetermined date (Step S31). When it is determined as “No” (Step S31/No), the control unit 110 waits until the predetermined date. When it is determined as “Yes” (Step S31/Yes), the control unit 110 reads the app-identification information for identifying an app installed in the terminal 10 and the information relating to the usage condition of the app from the app administration table for each terminal (Step S32). The control unit 110 selects a candidate app and a candidate terminal 10 based on the app-identification information and the information relating to the usage condition of the app (Step S33). For example, the control unit 110 refers to the app administration table for each terminal and detects an application installed in terminals of which number is a predetermined value or more and the operation time is a predetermined value or more. The control unit 110 selects the detected app as a candidate app to be served to the terminal 10. The control unit 110 refers to the app administration table for each terminal and detects terminals 10 in which the candidate app is not installed. The control unit 110 uses the detected terminal 10 as the candidate terminal 10. When the control unit 110 selects the candidate app and the candidate terminal 10, the control unit 110 outputs information for serving the candidate app to the candidate terminal 10 (Step S34). For example, the control unit 110 uses authentication information of a user of the candidate terminal 10 that is read from the user administration table and performs an authentication with the server device 200. The control unit 110 outputs the authentication information to the communication device 131. The communication device 131 sends the received authentication information to the server device 200. When the authentication with the server device 200 is succeeded, the control unit 110 outputs information for reporting a communication address of the candidate terminal 10 that is read from the user administration table and information requesting to serve the candidate app to the candidate terminal 10 for serving to the communication device 131. The communication device 131 sends the information received from the control unit 110 to the server device 200. Therefore, the server device 200 serves the candidate app to the candidate terminal 10. When the HDD 120 stores the candidate app, the control unit 110 reads the candidate app from the HDD 120 and sends the candidate app and the communication address of the candidate terminal 10 that serves the candidate app to the communication device 131.

As mentioned above in details, in the first embodiment, an app to be served and a terminal 10 to which the app is served are selected based on information relating to a usage condition of an app installed in the terminal 10. And, information for serving the selected app to the selected terminal 10 is output. It is therefore possible to serve an application software having high practicality to the terminal 10.

### Second Embodiment

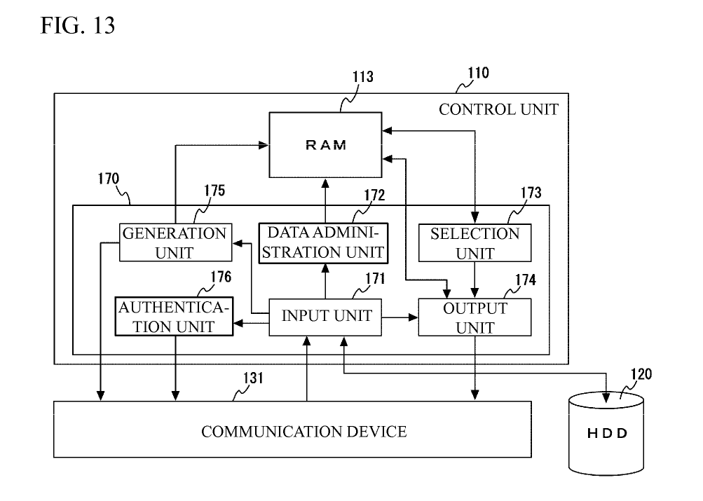

A description will be given of a second embodiment with reference to FIG. 13 to FIG. 18. The hardware having the terminal 10, the administration device 100 to serve applications and the server device 200 is the same as the first embodiment. Therefore, an explanation of the hardware is omitted. First, a description will be given of an example of the functional block 170 of the administration device 100 to serve applications with reference to FIG. 13. The administration device 100 to serve applications has a unit 175 to generate terminal-identification information and an authentication unit 176 in addition to the functional block 170 of the control unit 110 of the first embodiment.

The input unit 171 receives data that is received by the communication device 131 from the terminal 10. When the data is authentication information used for an authentication with the server device 200 or a communication address of the terminal 10 used for the communication with the terminal 10, the input unit 171 outputs the data to the unit 175 to generate terminal-identification information and the authentication unit 176. When the data is information relating to a usage condition of an app of the terminal 10 or the like, the input unit 171 outputs the data to the data administration unit 172. When the data is an app that is read from the HDD 120, the input unit 171 outputs the app to the output unit 174. The authentication information includes a user ID and a password for authenticating a user of the terminal 10 as well as the first embodiment. The communication address includes at least one of a MAC address and an IP address of the terminal 10.

The unit 175 to generate terminal-identification information receives the authentication information and the communication address that are output by the input unit 171. The unit 175 to generate terminal-identification information uses at least one of the authentication information and the communication address and generates terminal-identification information for specifying the terminal 10. When the terminal-identification information includes a communication address, the terminal-identification information includes at least one of a MAC address and an IP address. The unit 175 to generate terminal-identification information stores the generated terminal-identification information in the RAM 113. The unit 175 to generate terminal-identification information outputs the generated terminal-identification information to the communication device 131. The communication device 131 sends the terminal-identification information received from the unit 175 to generate terminal-identification information to the terminal 10 via the network 300.

The authentication unit 176 receives the authentication information and the communication address that are output by the input unit 171. The authentication unit 176 performs an authentication process with the server device 200 with use of the authentication information and the communication address. That is, the authentication unit 176 acts for the terminal 10 that sends the authentication information and the communication address to the administration device 100 to serve applications and performs the authentication with the server device 200. The authentication unit 176 sends the authentication information to the server device 200 and stores the authentication information for authenticating a user of the terminal 10 in the server device 200. The authentication unit 176 sends the communication address of the terminal 10 to the server device 200. Thereby, the server device 200 can serve an app to the terminal 10.

The data administration unit 172 receives terminal-identification information for identifying the terminal 10, app-identification information for identifying an app and information relating to a usage condition of an app from the input unit 171 as well as the above-mentioned first embodiment. The data administration unit 172 stores the received information in the RAM 113.

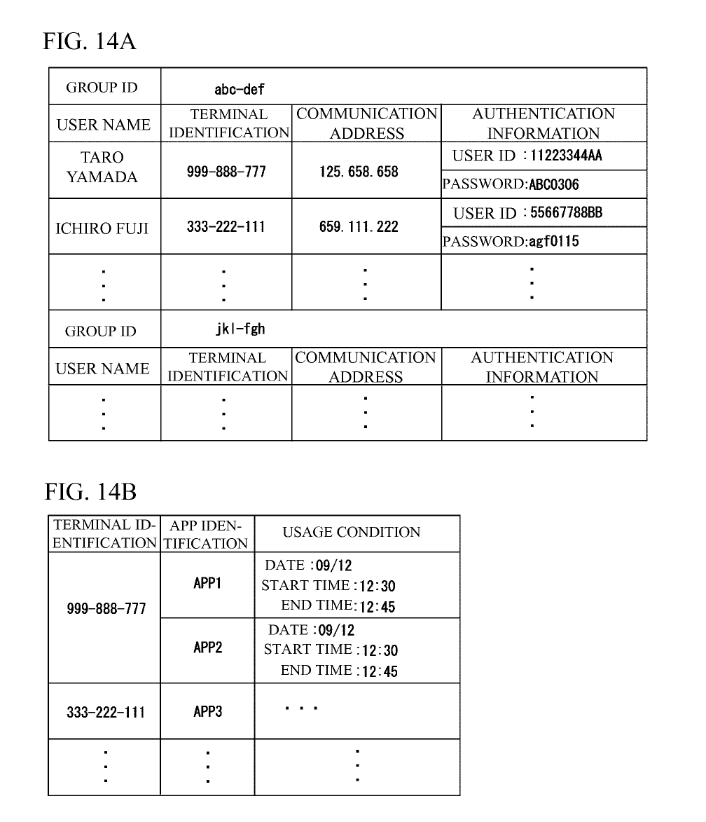

A description will be given of a group administration table and an app administration table for each terminal that are stored in the RAM 113, with reference to FIG. 14A and FIG. 14B. FIG. 14A illustrates an example of the group administration table. FIG. 14B illustrates an example of the app administration table for each terminal. The group administration table of FIG. 14A stores user names, terminal-identification information, communication addresses, authentication information that are related to group IDs for identifying the groups. The user name is a name joining a group. The terminal-identification information is information that is generated by the unit 175 to generate terminal-identification information and is information for identifying the terminal 10 of a user. The communication address is a communication address of the terminal 10 indicated by the terminal-identification information. The authentication information includes a password and a user ID for authenticating a user having a user name. The group is not limited specifically. For example, the group may be a group including company members belonging to an identical department of the company or a group including members belonging to a hobby circle.

The app administration table for each terminal of FIG. 14B stores app identification information and information relating to a usage condition that are related to terminal-identification information for identifying the terminal 10. The terminal-identification information is terminal-identification information that is generated by the unit 175 to generate terminal-identification information and is information for identifying the terminal 10 of a user. The app-identification information is information indicating an app installed in the terminal 10 indicated by the terminal-identification information. The information relating to the usage condition includes a date on which an app indicated by the app-identification information is used, a start time at which the app is started, and an end time at which the app is terminated.

A description will be given of the functional block 170 of the administration device 100 to serve applications with reference to FIG. 13. The selection unit 173 refers to the group administration table and the app administration table for each terminal of the RAM 113 and selects a candidate app and a candidate terminal 10. First, the selection unit 173 selects an objective group and reads terminal-identification information of a user belonging to the selected group from the group administration table. Next, the selection unit 173 refers to the app administration table for each terminal and reads app-identification information installed in the terminal 10 indicated by the terminal-identification information and information relating to a usage condition of the app. The selection unit 173 uses the app-identification information and the information relating to the usage condition of the app and selects a candidate app and the candidate terminal 10 to which the app is served. First, the selection unit 173 detects an app installed in terminals of which number is a predetermined value or more with use of the terminal-identification information and the app-identification information. Next, the selection unit 173 uses the information relating to the usage condition of the app and determines whether an operation time of the detected app is a predetermined time or more. When the operation time is the predetermined time or more, the selection unit 173 selects the detected app as a candidate app to be served to the terminal 10. The selection unit 173 selects a candidate terminal 10 to which the candidate app is served. The selection unit 173 refers to the app administration table for each terminal and selects the terminal 10 in which the candidate app is not installed as the candidate terminal 10 to which the app is served. The selection unit 173 performs a process of selecting the candidate app and a process of selecting the candidate terminal 10 with respect to each group. The selection unit 173 stores the app-identification information of the candidate app and the terminal-identification information of the candidate terminal 10 in the RAM 113 and outputs the app-identification information and the terminal-identification information to the output unit 174. The RAM 113 stores the app-identification information of the candidate app and the terminal-identification information of the candidate terminal 10 that are related to the group ID.

The output unit 174 receives the app-identification information of the candidate app and the terminal-identification information of the candidate terminal 10 that are output by the selection unit 173. The output unit 174 reads authentication information of the candidate terminal 10 indicated by the terminal-identification information from the group administration table (hereinafter referred to as a process of reading authentication information). Next, the output unit 174 performs an authentication with the server device 200 with use of the authentication information and requests the server device 200 to send an app indicated by the app-identification information to the candidate terminal 10 (hereinafter referred to as a process of requesting an application). The output unit 174 performs the process of reading authentication information and the process of requesting an application with respect to each group in which the candidate app and the candidate terminal 10 are selected. When the HDD 120 stores the candidate app that is read from the server device 200 in advance as in the case of the first embodiment, the output unit 174 reads the candidate app from the HDD 120 and serves the candidate app to the candidate terminal 10.

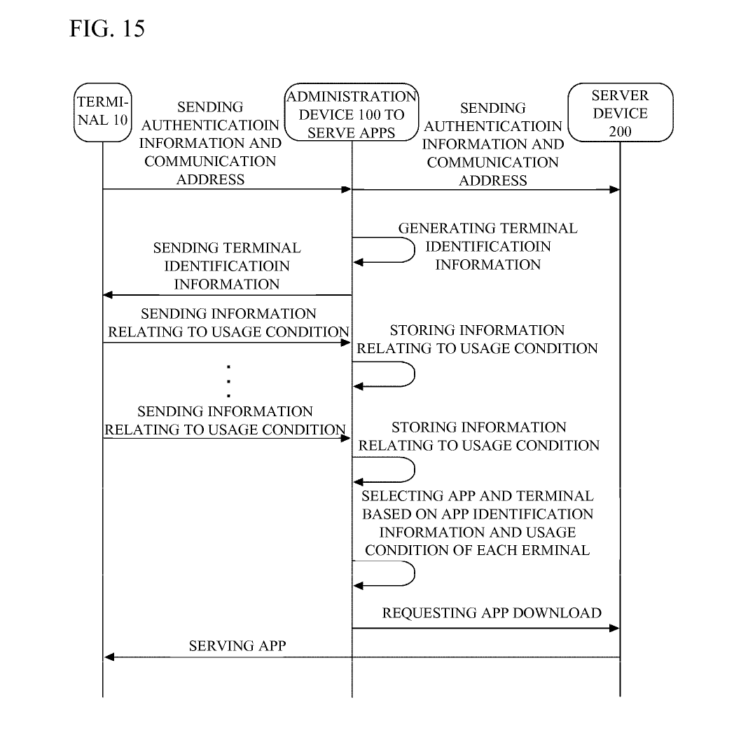

Next, a description will be given of a communication procedure among the terminal 10, the administration device 100 to serve applications and the server device 200, with reference to a sequence of FIG. 15. The terminal 10 sends authentication information and a communication address to the administration device 100 to serve applications. The authentication information is information needed for the authentication process with the server device 200. The administration device 100 to serve applications sends the authentication information and the communication address to the server device 200 and enrolls a user on behalf of the terminal 10. The server device 200 stores the authentication information and the communication address received from the administration device 100 to serve applications in the memory 212. The administration device 100 to serve applications generates terminal-identification information for identifying the terminal 10 with use of at least one of the authentication information and the communication address and sends the generated terminal-identification information to the terminal 10. When the terminal 10 receives the terminal-identification information from the administration device 100 to serve applications, the terminal 10 stores the terminal-identification information in the RAM 23. After that, the terminal 10 monitors a usage condition of an app installed in the terminal 10. When the terminal 10 detects a starting of the app, the terminal 10 relates a start time indicating a time at which the app is started to the app-identification information for identifying the app, and stores the start time in the RAM 23. When the terminal 10 detects a termination of the app, the terminal 10 relates an end time at which the app is terminated to the app-identification information for identifying the app in the RAM 23. The terminal 10 reads the app-identification information, the start time of the app and the end time of the app from the RAM 23 at every predetermined time, and sends them to the administration device 100 to serve applications. When the administration device 100 to serve applications receives a request of data sending from the terminal 10, the administration device 100 to serve applications receives the app-identification information, the information of the start time and the end time that are sent by the terminal 10 and stores the received information in the RAM 113. The administration device 100 to serve applications performs a selecting of the candidate app and a selecting of the candidate terminal 10 to which an app is served once every predetermined time. The administration device 100 to serve applications selects a candidate app and a candidate terminal 10 with use of the app-identification information of the terminal 10 belonging to a group, the information of the start time and the end time. When the administration device 100 to serve applications selects the candidate app and the candidate terminal 10, the administration device 100 to serve applications reads the authentication information of a user of the candidate terminal 10 from the group administration table. The administration device 100 to serve applications sends the authentication information to the server device 200 and performs an authentication with the server device 200. When the authentication is normally terminated, the administration device 100 to serve applications requests the server device 200 to serve the candidate app. The server device 200 serves the candidate app to the terminal 10 with use of the communication address stored in the memory 212.

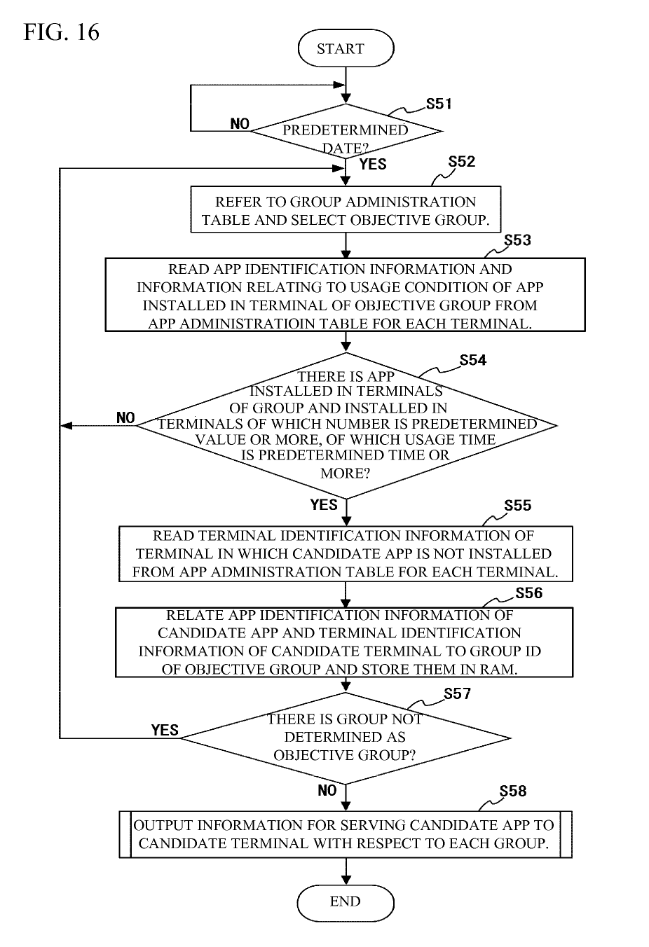

Next, a description will be given of a procedure of the embodiment with reference to a flowchart. The process of the terminal 10 is the same as the first embodiment. Therefore, an explanation of the process is omitted. A description will be given of a procedure in which the control unit 110 of the administration device 100 to serve applications selects a candidate app and a candidate terminal 10, with reference to a flowchart of FIG. 16. When a current time is a date predetermined in advance (Step S51), the control unit 110 starts the process of selecting a candidate app and a candidate terminal 10. The administration device 100 to serve applications performs the process of selecting the candidate app at a predetermined date such as once a week. The control unit 110 refers to the group administration table and selects an objective group (Step S52). Next, the control unit 110 refers to the app administration table for each terminal and reads app-identification information of an app installed in a terminal 10 belonging to the group and information relating to a usage condition of the app (Step S53). The control unit 110 uses the information and detects the app installed in terminals 10 belonging to the objective group. Further, the control unit 110 determines whether the detected applications include an application installed in terminals of which number is a predetermined value or more and has an operation time that is a predetermined time or more (Step S54). When an app satisfying the condition of Step S54 is detected (Step S54/Yes), the control unit 110 determines the detected app as a candidate app. The control unit 110 reads terminal-identification information of terminals 10 in which the candidate app is not installed from the app administration table for each terminal (Step S55). The control unit 110 determines the terminal 10 of which terminal-identification information is read as a candidate terminal. The control unit 110 relates the app-identification information of the candidate app and the terminal-identification information of the candidate terminal to a group ID of the objective group and stores the information in the RAM 113 (Step S56). Next, the control unit 110 determines whether there is a group that is not determined as the objective group (Step S57). When it is determined as “Yes” (Step S57/Yes), the control unit 110 determines the group as an objective group (Step S52). The control unit 110 performs the processes of Step S53 and after Step S53 with respect to the determined objective group. When it is determined as “No” (Step S57/No), the control unit 110 outputs information for serving the candidate app to the candidate terminal with respect to each group (Step S58). In the flowchart, an objective group is determined, information relating to a usage of an app of a terminal 10 belonging to the group is used, and a candidate app and a candidate terminal are selected. However, the determination of the objective group is not essential. An app satisfying the condition of Step S54 may be detected with use of information of a usage condition of apps of all groups without determination of the objective group.

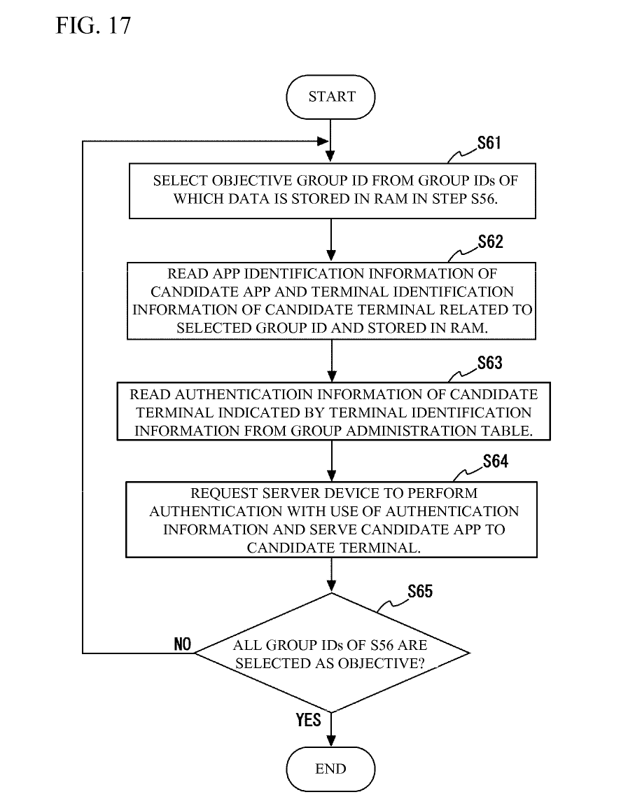

Next, a description will be given of a procedure in which the control unit 110 outputs a request of serving a candidate app to a candidate terminal to the server device 200 with reference to a flowchart of FIG. 17, as an example of detailed flow of Step S58 of FIG. 16. First, the control unit 110 selects an objective group ID from groups IDs of the groups of which candidate app and candidate terminal are selected (Step S61). That is, in Step S56, the control unit 110 selects the objective group ID from the group IDs that are related to the app-identification information and the terminal-identification information and are stored in the RAM 113. Next, the control unit 110 reads the app-identification information of the candidate app and the terminal-identification information of the candidate terminal that are related to the selected group ID and are stored in the RAM 113 from the RAM 113 (Step S62). Next, the control unit 110 reads authentication information of the candidate terminal 10 indicated by the terminal-identification information from the group administration table (Step S63). Next, the control unit 110 performs an authentication with the server device 200 with use of the authentication information. When the authentication is normally terminated, the control unit 110 requests the server device 200 to serve the candidate app indicated by the app-identification information to the candidate terminal 10 (Step S64). When the request of serving the candidate app to the candidate terminal 10 is terminated, the control unit 110 determines whether all of the groups stored in the RAM 113 in Step S56 are selected as the objective group ID (Step S65). When it is determined as “No” (Step S65/No), the control unit 110 selects an objective group ID (Step S61) and repeats the processes of Step S62 and after Step S62. When it is determined as “Yes” (Step S65/Yes), the control unit 110 terminates the process.

As described in details, in the second embodiment, an app that is installed in terminals of which number is a predetermined value or more and has an operation time that is a predetermined time or more is selected as an app having a high practicality. A terminal 10 in which the selected app is not installed is detected. And, the detected terminal 10 is determined as a candidate terminal 10 to which the app is served. The server device 200 is requested to serve the selected app to the candidate terminal 10. It is therefore possible to serve the app having high practicality to the terminal 10 in which the app is not installed. It is therefore possible to improve convenience of users. Users are administrated with respect to each group. An app of which use frequency is high is selected from apps that are installed in a terminal 10 of a user belonging to a group, based on the number of terminals in which the app is installed and an operation time of the app. It is therefore possible to serve an app of which use frequency is high among users belonging to the group and of which practicality is high to a terminal 10 in which the app is not installed. It is therefore possible to improve the convenience of users. And, the server device 200 to serve applications is provided. The administration device 100 to serve applications requests the server device 200 to serve a candidate app to a candidate terminal 10. It is therefore not necessary to store apps in the HDD 120 of the administration device 100 to serve applications. It is therefore possible to reduce capacity of the HDD 120.

(Modified Embodiment) In the above-mentioned second embodiment, an app having a high use frequency is selected based on the number of terminals in which the app is installed and an operation time of the app. In a modified embodiment, when at least a part of an operation time of an app of a user belonging to a group overlaps at least a part of an operation time of the app of another user belonging to the group, the app is selected in accordance with a determination reference in which the app has a high practicality in the group. For example, with high possibility, the users may have a talk with each other or study a work content via a common screen. Therefore, the app of which operation times overlap each other can be determined as an app having a high practicality in the group.

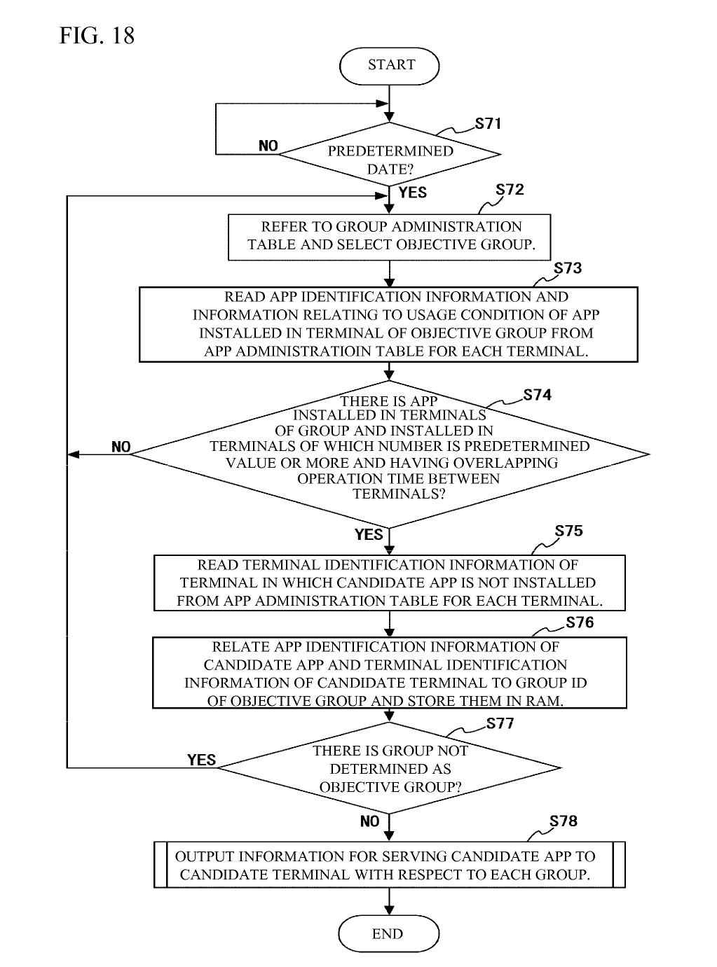

A description will be given of a procedure of the modified embodiment with reference to a flowchart of FIG. 18. A procedure in which the control unit 110 of the administration device 100 to serve applications reads app-identification information and information relating to a usage condition of a terminal 10 belonging to an objective group from an app administration table for each terminal is the same as the flow of FIG. 16. The control unit 110 uses the read information and detects an app that is an app installed in a terminal 10 belonging to a selected group and is installed in terminals 10 of which number is a predetermined value or more. Next, the control unit 110 determines whether the detected app is started by a plurality of terminals 10 and there is an overlapping operation time among the terminals 10 (Step S74). The app administration table of FIG. 14B stores app-identification information for identifying an app installed in the terminal 10, a date in which the app of the app-identification information is used, a start time and an end time. The control unit 110 refers to enrolled information of the app administration table for each terminal and determines whether there is an overlapping time among the operation times of the app. When an app satisfying the condition of Step S74 is detected (Step S74/Yes), the control unit 110 selects the detected app as a candidate app. The control unit 110 reads terminal-identification information of a terminal 10 in which the candidate app is not installed from the group administration table (Step S75). And, the control unit 110 relates the app-identification information of the candidate app to the terminal-identification information of the candidate terminal 10 and stores the app-identification information and the terminal-identification information in the RAM 113 (Step S76). The following procedure is the same as the flowchart of FIG. 16. Therefore, an explanation of the procedure is omitted. In the determination of Step S74, a threshold with respect to an overlapping operation time of an app among a plurality of terminals 10 is not provided. However, a threshold with respect to the overlapping time may be provided. For example, the more the number of the terminals 10 is, the shorter the threshold may be. For example, when the number of the terminals is three, it may be determined whether an application is a candidate app by determining whether an overlapping operation time of the three terminals is 10 minutes or more. When the number of the terminals is five, it may be determined whether an app is a candidate app by determining whether an overlapping operation time of the five terminals is five minutes or more. In the flowchart, an objective group is determined And, information relating to a usage condition of an app of a terminal 10 belonging to a group is used. And, a candidate app and a candidate terminal 10 are selected. However, the determination of the group is not essential. An app satisfying the condition of Step S74 may be detected with use of information relating to a usage condition of an app of all groups without determination of an objective group.

In the modified embodiment, an app of which operation times of users of an identical group overlap is determined as the app having high practicality and is selected. The terminal 10 in which the selected app is not installed is detected. The server device 200 is requested to serve the selected app to the terminal 10. It is therefore possible to serve the app having high practicality to the terminal 10 in which the app is not installed. It is therefore possible to improve the convenience of users.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the hardware of the administration device 100 to serve applications has the control unit 110 and the communication device 131. The other components of FIG. 2 may be provided or not provided in the administration device 100 to serve applications. Similarly, the hardware of the terminal 10 of FIG. 3 has the control unit 20. The other components of FIG. 3 may be provided or not provided in the terminal 10. In the above-mentioned first embodiment and second embodiment, the administration device 100 to serve applications is separately provided from the server device 200. However, the administration device 100 to serve applications may have the function of the server device 200. That is, the HDD 120 of the administration device 100 to serve applications may store apps, and the administration device 100 to serve applications may serve an app to the terminal 10.

What is claimed is:

1. An information processing device comprising:
a memory; and
a circuitry,
wherein the circuitry is configured:
to read identification information for identifying an application software installed in a terminal and information relating to a usage condition of the application software in the terminal from the terminal; and
to select a candidate application software and a candidate terminal to which the application software is served, based on the read identification information and the read information relating to the usage condition.

2. The information processing device as claimed in claim 1, wherein the circuitry is configured to output information for serving a selected application software to a selected terminal to a device configured to serve the application software.

3. The information processing device as claimed in claim 1, wherein:
the information relating to the usage condition includes information relating to an operation time of an application software; and
the circuitry is configured to select an application software that is installed in terminals of which number is a predetermined value or more, of which operation time is a predetermined time or more, based on the identification information and the usage condition, as the application software to be served.

4. The information processing device as claimed in claim 1, wherein:
the information relating to the usage condition includes information relating to a start time and an end time of an application software; and
the circuitry is configured to select an application software that is installed in terminals of which number is a predetermined value or more and has an overlapping operation time between a plurality of terminals, as the application software to be served.

5. The information processing device as claimed in claim 2, wherein:
the memory is configured to store identification information for identifying a terminal of a user with respect to each group to which the user belongs;
the circuitry is configured to select the application software to be served and the terminal to which the application software is served with respect to each group, based on the identification information and the information relating to the usage condition that are read from a terminal belonging to a group; and
the circuitry is configured to output information for serving the application software that is selected with respect to each group to the terminal that is selected with respect to each group.

6. The information processing device as claimed in claim 2, wherein the circuitry is configured to request a server device that serves the application software to serve the application software that is selected to the terminal that is selected.

7. A system comprising:
an information processing device that has a memory and a circuitry, the circuitry being configured to read identification information for identifying an application software installed in a terminal and information relating to a usage condition of the application software in the terminal from the terminal and to select a candidate application software and a candidate terminal to which the application software is served, based on the read identification information and the read information relating to the usage condition; and
the terminal that has a memory and a circuitry, the circuitry being configured to send the identification information and the information relating to the usage condition of the application software to the information processing device.

8. The system as claimed in claim 7, wherein the circuitry of the information processing device is configured to output information for serving a selected application software to a selected terminal to a device configured to serve the application software.

9. The system as claimed in claim 7, wherein:
the information relating to the usage condition includes information relating to an operation time of an application software; and
the circuitry of the information processing device is configured to select an application software that is installed in terminals of which number is a predetermined value or more, of which operation time is a predetermined time or more, based on the identification information and the usage condition, as the application software to be served.

10. The system as claimed in claim 7, wherein:
the information relating to the usage condition includes information relating to a start time and an end time of an application software; and
the circuitry of the information processing device is configured to select an application software that is installed in terminals of which number is a predetermined value or more and has an overlapping operation time between a plurality of terminals, as the application software to be served.

11. The system as claimed in claim 8, wherein:
the memory of the information processing device is configured to store identification information for identifying a terminal of a user with respect to each group to which the user belongs;
the circuitry of the information processing device is configured to select the application software to be served and the terminal to which the application software is served with respect to each group, based on the identification information and the information relating to the usage condition that are read from a terminal belonging to a group; and
the circuitry of the information processing device is configured to output information for serving the application software that is selected with respect to each group to the terminal that is selected with respect to each group.

12. The system as claimed in claim 8, wherein the circuitry of the information processing device is configured to request a server device that serves the application software to serve the application software that is selected to the terminal that is selected.

13. An information processing method comprising:
reading identification information for identifying an application software installed in a terminal and information relating to a usage condition of the application software in the terminal from the terminal; and
selecting a candidate application software and a candidate terminal to which the application software is served, based on the identification information and the information relating to the usage condition that are read in the reading.

14. The information processing method as claimed in claim 13 further comprising outputting information for serving an application software selected in the selecting to a terminal selected in the selecting to a device configured to serve the application software.

15. The information processing method as claimed in claim 13, wherein:
the information relating to the usage condition includes information relating to an operation time of an application software; and
in the selecting, an application software that is installed in terminals of which number is a predetermined value or more, of which operation time is a predetermined time or more, is selected based on the identification information and the usage condition, as the application software to be served.

16. The information processing method as claimed in claim 13, wherein:
the information relating to the usage condition includes information relating to a start time and an end time of an application software; and
in the selecting, an application software that is installed in terminals of which number is a predetermined value or more and has an overlapping operation time between a plurality of terminals is selected as the application software to be served.

17. The information processing method as claimed in claim 14, wherein:
in the selecting, identification information for identifying a terminal of a user stored in a memory is referred to with respect to each group to which the user belongs, and the application software to be served and the terminal to which the application software is served are selected based on the identification information and the information relating to the usage condition that are read from a terminal belonging to a group; and
in the outputting, information for serving the application software that is selected with respect to each group to the terminal that is selected with respect to each group is output.

18. The information processing method as claimed in claim 14, wherein in the outputting, a server device that serves the application software is requested to serve the application software that is selected in the selecting to the terminal that is selected in the selecting.

19. A computer readable non-transitory medium storing a program that causes a computer to execute a process, the process comprising:
reading identification information for identifying an application software installed in a terminal and information relating to a usage condition of the application software in the terminal from the terminal; and
selecting a candidate application software and a candidate terminal to which the application software is served, based on the identification information and the information relating to the usage condition that are read in the reading.

20. The medium as claimed in claim 19, wherein the process further comprising outputting information for serving an application software selected in the selecting to a terminal that is selected in the selecting to a device configured to serve the application software.

21. The medium as claimed in claim 19, wherein:
the information relating to the usage condition includes information relating to an operation time of an application software; and
in the selecting, an application software that is installed in terminals of which number is a predetermined value or more, of which operation time is a predetermined time or more, is selected based on the identification information and the usage condition, as the application software to be served.

22. The medium as claimed in claim 19, wherein:
the information relating to the usage condition includes information relating to a start time and an end time of an application software; and
in the selecting, an application software that is installed in terminals of which number is a predetermined value or more and has an overlapping operation time between a plurality of terminals is selected as the application software to be served.

23. The medium as claimed in claim 20, wherein:
in the selecting, identification information for identifying a terminal of a user stored in a memory is referred to with respect to each group to which the user belongs, and the application software to be served and the terminal to which the application software is served are selected based on the identification information and the information relating to the usage condition that are read from a terminal belonging to a group; and
in the outputting, information for serving the application software that is selected with respect to each group to the terminal that is selected with respect to each group is output.

24. The medium as claimed in claim 20, wherein in the outputting, a server device that serves the application software is requested to serve the application software that is selected in the selecting to the terminal that is selected in the selecting.
